(19) United States
(12) Patent Application Publication
(10) Pub. No.: US 2023/0134409 A1
(43) Pub. Date: May 4, 2023

(54) Robot System

(71) Applicant: ABB Schweiz AG, Baden (CH)

(72) Inventors: Christoph Byner, Mannheim (DE); Rene Kirsten, Fernwald (DE); Bjoern Matthias, Bad Schönborn (DE); Debora Clever, Zwingenberg (DE); Harald Staab, Neckargemünd (DE)

(73) Assignee: ABB Schweiz AG, Baden (CH)

(21) Appl. No.: 17/977,119

(22) Filed: Oct. 31, 2022

(30) Foreign Application Priority Data
Oct. 31, 2021 (DE) 202021105955.9

(51) Int. Cl. B25J 9/00; F16P 3/12; B25J 13/08; B25J 11/00

(52) U.S. Cl. CPC B25J 9/0096; B25J 11/005; B25J 13/085; F16P 3/12; B25J 19/06

(57) ABSTRACT

A robot system includes a robot, the robot including a base and an end effector that is movable relative to the base; and a processing target, the processing target being approachable by the end effector along at least one preferred direction; wherein the processing target is mounted movably relative to the base at least temporarily and at least in the preferred direction.

### CROSS-REFERENCE TO RELATED APPLICATIONS

This patent application claims priority to German Patent Application No. 202021105955.9, filed on Oct. 31, 2021, which is incorporated herein in its entirety by reference.

### FIELD OF THE DISCLOSURE

The present disclosure relates to a robot system having an end effector movable by utilizing an articulated arm or a gantry, and a machining target on which machining is to be performed by the end effector.

### BACKGROUND OF THE INVENTION

When a robot system is to operate in a space to which also humans have access, precautions must be taken to minimize the risk of injury from the robot, e.g., by setting the highest permissible speed of a robot in the vicinity of a human low enough so that the robot can be brought to a safe stop before it touches the human. Such an approach is feasible when humans and robots come close to each other only occasionally, for example, because a human walks past the robot without interacting with it. However, if the two must come close for long periods of time, for example when working together on a workpiece, then the associated close distance and long duration of the human’s stay near the robot enforces a tight limit on the maximum speed over a considerable period of time. The associated low productivity makes collaborative work between humans and robots uneconomical in many cases.

### BRIEF SUMMARY OF THE INVENTION

In one general aspect, the present disclosure describes a robot system that ensures effective protection of humans during collaborative work even when the maximum speed of the robot is less strictly limited, in particular when the robot is not brought to a standstill before contact between humans and robots occurs, but contact is also permitted while the robot is moving.

In one embodiment, the robot system in accordance with the disclosure includes a robot comprising a base and an end effector movable relative to the base, and a processing target, which can be approached by the end effector in at least one preferred direction, the machining target is mounted movably relative to the base at least temporarily and at least in the preferred direction.

### BRIEF DESCRIPTION OF THE SEVERAL VIEWS OF THE DRAWING(S)

FIG. 1 is a block diagram of a robot system in accordance with the disclosure, which includes an uncontrolled actuator.

FIG. 2 is a schematic view of an enlarged portion of the robot system of FIG. 1.

FIG. 3 is a block diagram of an alternative embodiment for an uncontrolled actuator for use with the system shown in FIG. 1, in accordance with the disclosure.

FIG. 4 is a block diagram of a second embodiment for a robot system having a controlled actuator in accordance with the disclosure.

FIG. 5 is an enlarged detail view of an actuator in accordance with the disclosure.

FIG. 6 is a block diagram of an alternative embodiment of the embodiment shown in FIG. 4 in accordance with the disclosure.

### DETAILED DESCRIPTION OF THE INVENTION

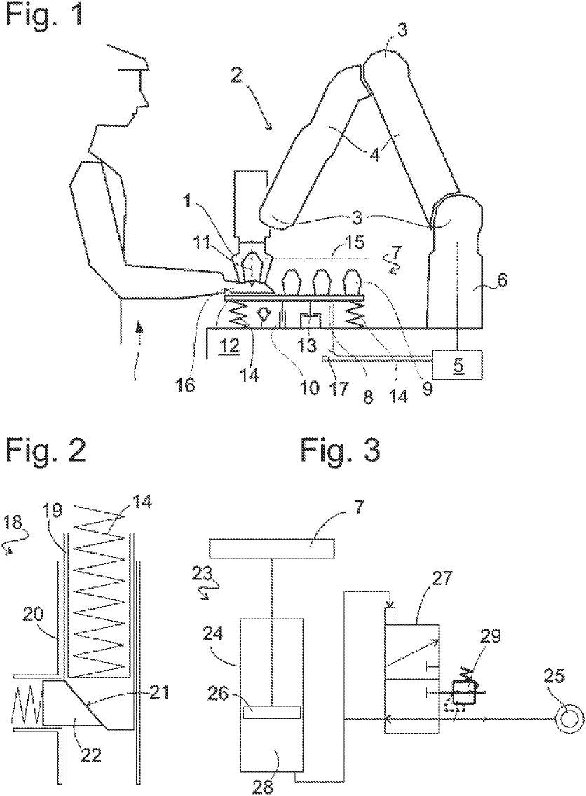

FIG. 1 schematically shows a robot system according to a first embodiment of the present disclosure. An end effector 1 is located at the free end of a robot arm 2 having a plurality of links 4 each connected by joints 3. A control unit 5 is provided to control the movement of the end effector 1 and is connected to angular sensors, not shown, at the joints 3 to enable the position of the end effector 1 to be calculated in a coordinate system that is fixed with respect to a base 6 of the robot arm.

Herein, a processing target 7 of the robot comprises a plate 8 with workpieces 9 loosely placed thereon, and the processing to be performed by the robot arm 2 at this processing target 7 is gripping a workpiece 9 by means of the end effector 1. The main functional aspects explained below with reference to this example are straightforwardly transferable to other processing targets, processing operations and end effectors.

One or more guide rails 10 define a preferred direction 11 in which the processing target 7 can be moved under a force applied to it from the outside, e.g., by a person or the robot arm 2; in the case considered here, the preferred direction 11 is downwards, perpendicular to the surface of the plate 8. The freedom of movement of the plate 8 is limited in the preferred direction 11 by a desktop 12, on which the base 6 of the robot arm is also mounted; and against the preferred direction by a stop 13. Actuators, here in the form of coil springs 14, exert a force on the plate 8 against the preferred direction 11 and, in its rest position, keep it pressed against the stop 13.

The control unit 5 is arranged to calculate, in knowledge of the rest position of the plate 8 and, if necessary, of the dimensions of the workpieces 9 thereon, a boundary surface 15 in such a way that between it and the workpieces 9 there is space at least for the hand 16 of a person, preferably in such a way that between the hand and the boundary surface 15 the minimum distance of 100 mm defined in ISO 13854 is maintained. As long as the end effector 1 is on the side of the boundary surface 15 facing away from the machining target 7, there is no possibility of trapping the hand 16; the direction in which the control unit 5 can move the end effector 1 is therefore not subject to any restrictions. However, as soon as the end effector 1 passes the boundary surface 15, the control unit 5 allows movements that bring the end effector 1 closer to the machining target 7 only in the preferred direction 11 or with a limited angular deviation from it, in order to protect the hand 16 from shearing forces in a transverse direction in which the machining target 7 cannot follow a movement of the end effector 1, in case the hand 16 actually gets caught between the end effector 1 and the machining target 7.

Furthermore, beyond the interface 15 the control unit 7 limits the speed of the end effector 1 to a value at which the braking distance of the end effector 1 is no longer than the freedom of movement of the processing target 7 along the rail 10, so that when the hand 16 comes between the end effector 1 and the plate 8 as shown in FIG. 1, the robot arm 2 can bring the end effector 1 to a stop before the plate 8 strikes the desktop 12.

The robot arm 2 may be equipped with sensors that allow the control unit 5 to detect forces acting on the robot arm 2 from the outside. When the hand 16 is located between the end effector 1 and a workpiece 9 to be picked up and is clamped in the course of the movement of the end effector 1 towards the workpiece 9, this can be recognized by the control unit 5 based on an unforeseen increase in the resistance to be overcome by the robot arm 2; the control unit 5 can take account of this by initiating an immediate braking of the robot arm 2. Although the latter does not come to an immediate stop as a result of its inertia, the fact that the machining target 7 can yield in the preferred direction 11 means that the force to which the hand 16 is subjected during deceleration can be limited to a permissible, harmless level. Since the end effector 1 comes to a standstill before the freedom of movement of the machining target is exhausted, the force acting during the standstill can also be limited to a harmless level; moreover, the person has the possibility of further deflecting the machining target 7 to the end of its freedom of movement, so as to create a free space between it and the end effector 1 which is needed to free the hand 16.

According to a simplified variant, monitoring of the forces acting on the end effector 1 as it approaches the processing target 7 can be dispensed with if the processing target 7 is provided with a switch 17 indicating its deflection from the rest position. As soon as this switch 17 responds, this is an indication of a foreign body between the end effector 1 and the machining target 7, which causes the control unit 5 to stop the movement of the end effector 1.

The counterforce exerted by the coil springs 14 on the machining target 7 increases with its deflection from the rest position. This is disadvantageous in that ISO/TS 15066:2016 limits more tightly for the clamping force acting in the quasi-static state, after the end effector 1 has stopped, than the force acting at initial contact or during deceleration, whereas the tension on the spring continues to increase as the end effector 1 decelerates. Secondly, the force which must be exerted on the machining target 7 to free the hand 16 after the end effector 1 has come to a standstill is greater than the force with which the latter is held pressed against the stop 13 in the rest state. To remedy this, a spring assembly 18 as shown in FIG. 2 can be provided as an actuator instead of each of the simple helical springs 14: here a helical spring 14 is accommodated in two telescopic sleeves 19, 20; one end of the helical spring acts on the machining target 7 (not shown), the other on a bottom of the inner sleeve 19. A wedge surface 21 of the inner sleeve interacts with a spring-loaded projection 22 projecting into the outer sleeve 20.

When the tension of the spring 14 exceeds a limit, it forces the projection 22 back; the sleeve 19 slides past the projection 22, and the spring 14 relaxes. If this occurs while the end effector 1 is still decelerating, the spring 14 will then be largely relaxed when the end effector 1 comes to a stop, and a small force will be sufficient to force the machining target 7 further back against the spring 14 and free the hand.

According to the variant of FIG. 3, an actuator 23 comprises a cylinder 24 which is connected to a pressure source 25 and a piston 26 of which supports the machining target 7. A directional control valve 27 is arranged on a line between pressure source 25 and cylinder 24, and is controlled by a pressure acting in a working chamber 28 of cylinder 24: if this pressure exceeds a limit, then the directional control valve disconnects the connection to pressure source 25 and connects the working chamber to atmospheric pressure instead via a pressure relief valve 28. As long as the directional control valve 27 remains in this position, the actuator 23 does not exert any counterforce on the machining target 7 and the hand clamped between it and the end effector 1, and in order to create the freedom of movement necessary to free the hand, it is sufficient to overcome the hydrostatic pressure in the working chamber 28, which is independent of the displacement of the piston 26.

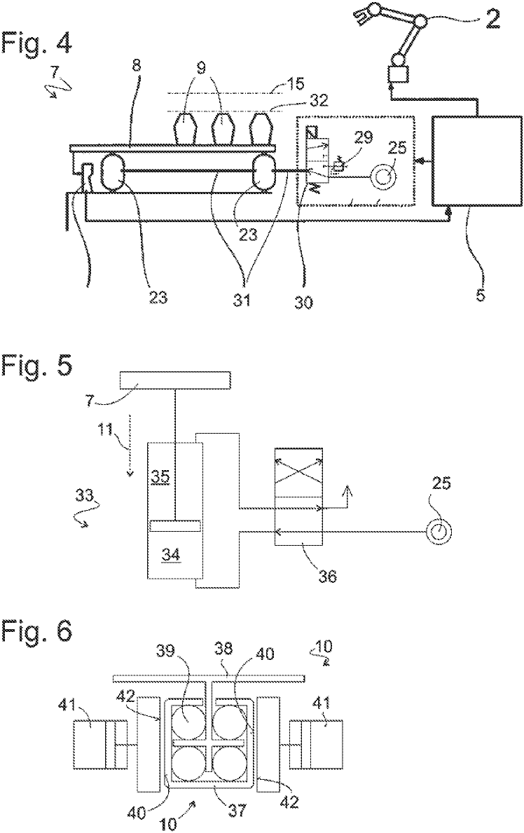

FIG. 4 shows a schematic representation of a robot system according to a second embodiment of the disclosure. The robot arm 2 and the processing target 7 may be identical to those of FIG. 1. Cylinders connected to a pressure source 25 via a line 31 are provided as actuators 23 as in FIG. 3. Again, a switch 17 is provided to respond to a deflection of the machining target 7, and a directional control valve 30 connects the pressure source 25 to the actuators 23. Unlike the case of FIG. 3, however, this directional control valve 30 is controlled electrically, by the control unit 5, rather than by pressure. As in FIG. 1, an boundary surface 15 is defined such that there is space between it and the workpieces 9 for at least the hand 16 of a person. As long as the end effector 1 is on the side of the boundary surface 15 facing away from the processing target 7, the control unit 5 can hold the directional control valve 30 in its position shown in the Fig., in which the cylinders communicate with the pressure source 25 so that a high pressure prevails in the cylinders. As soon as the end effector 1 crosses the boundary surface 15 toward the processing target 7, the control unit 5 switches the directional control valve 30 to its second position, in which the pressure in the cylinders is determined by a pressure relief valve 29. This pressure is low enough to limit the clamping force to a low value compatible with ISO/TS 15066:2016 in the event that a foreign object is clamped between the machining target 7 and the end effector 1.

A second boundary surface 32 extends in such close proximity to the processing target 7 that there is no space between it and the processing target for a person’s hand or finger. When the end effector 1 has crossed this boundary surface 32 without deflecting the machining target 7, i.e. without the switch 17 having responded, then there is no longer any danger of a boy part getting caught, and the directional control valve 30 can be returned to the first position. This has little significance for the example case shown, in which the machining operation is gripping a workpiece and exerts essentially no force on the plate 8; in the case of a machining operation in which a force is exerted on the workpiece in the preferred direction, such as a drilling operation, this ensures that the workpiece does not yield to the pressure of the drill.

FIG. 5 shows a cylinder of an actuator 33 according to a modification of the structure of FIG. 3. The cylinder has two working chambers 34, 35. A directional control valve 36 here has a first position in which the pressure source 25 communicates with the working chamber 34 facing away from the machining target 7, while the working chamber 34 facing the machining target 7 is maintained at ambient pressure. Thus, the overpressure in the working chamber 34 keeps the machining target 7 firmly pressed against its stop in a direction opposite to the preferred direction 11. When the processing unit detects that an external force opposes a movement of the end effector 1 in the preferred direction, it not only triggers a deceleration of the end effector 1, but simultaneously moves the directional control valve 36 to a second position in which the working chamber 35 is pressurized with high pressure from the source 25 and the working chamber 34 is set to ambient pressure. Thus, in the event that the external force is due to a foreign object, such as a person’s hand, trapped between the end effector 1 and the machining target 7, the pressure source 25 drives an active retraction of the machining target. Since the force driving the retraction does not need to be transmitted from the end effector 1 to the machining target 7, or only partially, the hand in between is protected from injury.

FIG. 6 schematically shows a detail of a further modification in a schematic cross-section. The sectional plane extends transversely to the preferred direction through a rail 10 guiding the movement of the machining target 7. A part of the rail 10 movable with the machining target 7 is designated 37, and one connected to the desktop 12 (not shown) is designated 38. To prevent jamming, roller bearings 39 may be provided between the parts 37, 38. Flanks of the movable part 37 are formed as friction surfaces 40, which are face friction surfaces 42 actuated by actuators 41 mounted on the desktop 12.

When the end effector 1 is located between the boundary surfaces 15 and 32, the control unit keeps the friction surfaces 40, 42 spaced apart from each other or pressed against each other so weakly that the machining target 7 yields easily to a pressure applied thereto in the preferred direction; else, the actuators 41 apply a high braking pressure to the part 37 so that the machining target 7 does not yield even to a pressure applied by the end effector 1 during machining.

List Reference signs
1 end effector
2 robot arm
3 joint
4 link
5 control unit
6 base
7 processing target
8 plate
9 workpiece
10 guide rail
11 preferred direction
12 desktop
13 stop
14 helical spring (actuator)
15 boundary surface
16 hand
17 switch
18 spring assembly
19 inner sleeve
20 outer sleeve
21 wedge surface
22 protrusion
23 actuator
24 cylinder
25 pressure source
26 piston
27 directional valve
28 working chamber
29 pressure relief valve
30 directional valve
31 line
32 boundary surface
33 actuator
34 working chamber
35 working chamber
36 directional valve
37 moveable part
38 connected part
39 roller bearing
40 friction surface
41 actuator
42 friction surface

In a general aspect, the robot systems described herein reduce the risk of injury of humans from contact with a robot. Such risk may be particularly high for humans if they are unable to retreat from the robot’s impact, especially when motion of the user is limited between the robot and an obstacle. While obstacles in the form of objects that are not needed for the robot’s work can be removed from the robot’s environment, thus eliminating the risk of a human being caught between them and the robot, this is obviously not the case for a machining target of the robot, such as a workpiece. Since the number of machining targets that are in the vicinity of a robot at any one time is generally small, safety measures for them in the form of compliant mounting can be taken with manageable effort. In particular, if the inertia of the machining target is lower than that of the robot, the force temporarily acting on a human body part while the end effector is decelerated and the machining target is accelerated can be reduced highly effectively.

In particular, the machining target may comprise a workpiece holder and, possibly, a workpiece. In the context of the present invention a workpiece holder can be a receptacle in which the workpiece is positively held, clamped or otherwise temporarily fixed, as well as a container or a support on which the workpiece rests loosely and can be gripped by the end effector or on which it can be set down by the end effector.

An actuator may be connected to the machining target to counteract a deflection of the machining target in the preferred direction, so as to prevent the machining target from backing away from the end effector during normal operation, i.e., when no temporary safety measures are taken to protect a human being in the vicinity of the robot.

The actuator can be uncontrolled, e.g. it can be elastically deformable, so that the counterforce is a reaction force counteracting the deformation of the actuator. The counterforce should be low enough to be compatible with the limit values specified in ISO/TS 15066:2016 for forces acting transiently or quasi-statically on a human body part, e.g. 280 N or 140 N for the hand. For example, in order not to exceed the limit value for the force acting quasi-statically, the preload and spring constant of the actuator must be matched to the braking distance (and thus to the maximum permissible speed of the end effector) in such a way that, if the processing target is deflected by the end effector and the body part clamped in between, the counterforce will remain below the limit value from the start of clamping to the standstill of the end effector.

In order for machining to be performed by the end effector without causing the machining target to be pushed back, the counterforce exerted by the elastic actuator on the machining target in a rest position thereof against the preferred direction must be greater than a force exerted by the end effector in the preferred direction during machining. For this purpose, the elastic actuator can be preloaded so that it keeps the machining target pressed against a stop in the rest position.

This preload inevitably reduces the distance by which the machining target can be pushed back before the counterforce of the actuator exceeds the limit value. To avoid this disadvantage, the actuator can be supported at a weak point which yields when a load limit is exceeded, preferably below the limit value, thus allowing the actuator to relax.

Alternatively, the actuator can be controllable to vary the counterforce opposing the deflection of the machining target from a rest position as required.

For this purpose, the actuator may have at least one working chamber containing a fluid, and means may be provided to vary the counterforce by varying the pressure of the fluid.

The robotic system may further comprise a stationary friction surface and a friction surface movable with the processing target, and the actuator may be arranged to control the counterforce via a contact pressure applied to the friction surfaces.

Alternatively, the working chamber can be compressible by deflecting the machining target from its rest position, e.g. by providing a piston of the working chamber that is coupled to the machining target and is displaced together with the target.

A control unit can interact with the actuator to set the counterforce to a low value at least when the end effector approaches the machining target, since only then is there a possibility of a body part being trapped between the end effector and the machining target. The counterforce does not have to be reduced for every approaching movement; as an additional condition, it can be provided that the distance between the end effector and the machining target falls below a limit distance that is adapted to the dimension of a body part, in particular a hand, that is at risk of being trapped.

Conversely, the control unit should set the counterforce to a high value at least when the end effector is in contact with the machining target and consequently no body part can be present between the end effector and the machining target, but at the same time a high counterforce of the machining target may be necessary for the intended machining.

In order to minimize the risk of injury due to shear forces, the control unit can be set up to limit a deviation of the direction of a further approach of the end effector to the processing target from the preferred direction if the distance between the end effector and the processing target falls below a limit distance.

In order to provide effective protection even in the case of high inertia of the machining target, for example if it comprises a heavy workpiece such as a car body, the actuator can be set up to drive a movement of the machining target in the preferred direction.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A robot system comprising:
a robot, the robot including a base and an end effector that is movable relative to the base; and
a processing target, the processing target being approachable by the end effector along at least one preferred direction;
wherein the processing target is mounted movably relative to the base at least temporarily and at least in the preferred direction.

2. The robot system of claim 1, wherein the processing target comprises a workpiece holder.

3. The robot system of claim 1, further comprising an actuator connected to the processing target for opposing a deflection of the processing target in the preferred direction with a counterforce.

4. The robot system of claim 3, wherein the actuator is elastically deformable and the counterforce is a reaction force counteracting the deformation of the actuator.

5. The robot system of claim 4, wherein the reaction force exerted by the elastic actuator on the processing target in a rest position thereof, the rest position defined by a stop, is greater than a force exerted on the processing target in the preferred direction by the end effector during a machining operation.

6. The robot system of claim 3, wherein the actuator is supported at a weak point that is configured to yield when a load limit is exceeded.

7. The robot system of claim 3, wherein the actuator is controllable to vary the counterforce opposing the deflection of the processing target from a rest position.

8. The robot system of claim 7, wherein the actuator comprises at least one working chamber containing a fluid, and wherein a pressure of the fluid is variable to vary the counterforce.

9. The robot system of claim 7, further comprising a first friction surface that is stationary in the preferred direction and a second friction surface that is displaceable with the processing target, the actuator being arranged to control a contact pressure of the first and second friction surfaces against one another.

10. The robot system of claim 8, wherein the working chamber is compressible by a deflection of the processing target from the rest position.

11. The robot system of claim 7, further comprising a control unit configured to cooperate with the actuator and to set the counterforce to a low value at least when the end effector approaches the processing target and to set the counterforce to a high value at least when the end effector contacts the processing target.

12. The robot system of claim 7, further comprising a control unit configured to cooperate with a force sensor or a deflection sensor associated with at least one of the end effector and the processing target, the force or deflection sensor configured to detect, in a state in which the end effector and the processing target are spaced apart from each other, an external force opposing an approach of the end effector and the processing target, or a deflection of the processing target, and to set the counterforce of the actuator to a low value when the external force or the deflection is detected.

13. The robot system of claim 1, further comprising a control unit configured to limit a deviation in a direction of a further approach from the preferred direction when a distance between the end effector and the processing target drops below a limit distance.

14. The robot system of claim 1, further comprising an actuator configured to drive a movement of the processing target in the preferred direction.
